(19) United States
(12) Patent Application Publication
(10) Pub. No.: US 2011/0167257 A1
(43) Pub. Date: Jul. 7, 2011

(54) Method for issuing, verifying, and distributing certificates for use in public key infrastructure

(76) Inventor: Sven Gossel, Munchen (DE)

(21) Appl. No.: 12/830,167

(22) Filed: Jul. 2, 2010

(30) Foreign Application Priority Data
Jul. 3, 2009 (DE) 10 2009 031 817.8

(51) Int. Cl. H04L 9/00

(52) U.S. Cl. 713/156

(57) ABSTRACT

The invention relates to a method for issuing, verifying, and distributing digital certificates for use in Public Key Infrastructure, in which a requester 3, 5 requests a digital certificate at a digital certificate authority 11, wherein at least one set of third-party information 21 on the certificate holder 3 is referenced for evaluating a confidence status for the certificate of a certificate holder (3). Furthermore, the invention relates to a digital certificate authority as well as to an arrangement made from such a certificate authority and at least one subscriber station of a certificate user 5 connected to this authority by means of a digital network for carrying out such a method.

The invention relates to a method for issuing, verifying, and distributing digital certificates for use in Public Key Infrastructure (PKI). Such methods are used in computer-assisted communications on digital networks, in particular, on the Internet, for example, for the secure retrieval of Web pages, for the secure transmission of e-mails or other data, and for the secure execution of corresponding applications or objects.

For example, with the help of an asymmetric cryptosystem, messages on a network are signed and encrypted digitally with the suitable selection of the encryption parameters, especially the key length, such that, even with knowledge of the method, misuse can be prevented at least within a reasonable time.

For encrypting a message, the sender needs the Public Key of the receiver, which can be, for example, downloaded from a website or sent by e-mail. Digital certificates are used for authentication, wherein these certificates confirm the authenticity of the public key and its permissible field of use and application.

Digital certificates for proving the authenticity of objects are generally issued by digital certificate authorities, that is, a corresponding server (computer) or system running on this server.

Despite the high degree of security against misuse that can be achieved by PKI systems, unfortunately these are not widely and quickly distributed in computer-assisted communications.

The reason for this is that Public Keys, both in the case of hierarchical PKI systems (for example, the X.509 standard) and also in the so-called Web of Trust approach (even for regular participation of Key Signing Parties), cannot be distributed simply, quickly, and conveniently, as well as with sufficient security against misuse.

Therefore, the invention is based on the task of creating a method that allows a quick and convenient distribution of Public Key Infrastructure.

This task is achieved according to the invention by a method with the features of Claim 1, as well as by a digital certificate authority with the features of Claim 9 and an arrangement made from such a digital certificate authority according to Claim 9 and at least one subscriber station connected to this authority by means of a digital network according to Claim 10.

According to the invention, certificates are issued more easily by a central digital certificate authority in the form of a hierarchical PKI system for the authentication of Public Keys, for example, for encrypted e-mail transmission, for better security in Internet shopping (e-stores), applications that require certificates for security (signature, encryption, or the like), etc., and are nevertheless distributed with an adequate confidence level or confidence status in the digital network, in that, for evaluating a confidence status for the certificate, at least one set of third-party information on the certificate holder is referenced. Here, third parties can be certificate users and/or other persons or devices, such as, for example, other digital certificate authorities, social networks, etc., or related servers (in contrast to a certificate holder and the certificate authority at which the certificate is to be requested and issued).

The third-party information on the certificate holder in general or its certificate directly can be, for example, certificates of other certificate authorities of this same holder (identified by means of his e-mail address or by means of other identity information, such as first name and last name, etc.). In addition, third parties could also complain to the certificate authority about spam that was sent from the certificate holder, so that the corresponding is classified as invalid or its issuing is rejected. In addition, a behavior evaluated by third parties or a confidence status on the certificate holder demanded by third parties in other fields, such as, for example, for Web auctions, discussion forums, etc., can be used as information for evaluating a confidence status by the certificate authority for the certificate. Thus, it is also conceivable to use, as the third-party information, information from a telephone network operator, such as the individual telephone number, or other unique subscriber identifying properties (such as, for example, in mobile radio, in addition to the telephone number, the IMSI, CCID, or even the device identifier IMEI in the case of limited devices, etc.), in order to present a confidence status demanded in other fields.

Such information (third-party confirmations) can be delivered by the certificate holder himself in the application or transmitted at a later time, possible also at the request of the certificate authority, in order to increase the confidence status. It is also conceivable that the certificate authority retrieves information present there (history, rank, complaints, confirmations. etc.) on the certificate holder at least with the transmitted or at the request of the granted permission for other digital, Web-based certificate authorities (in the digital network) and/or digital or Web-based social networks (for example, Facebook, LinkedIn, XING, MySpace, etc.).

The information could also be used for confirming only parts of the identity (attributes) of the certificate holder, such as, for example, his address.

According to the invention it is also conceivable that third parties complain about misuse of a certificate or improper behavior of the certificate holder after issuing or confirm or verify conforming behavior at the certificate authority, so that this information leads directly to a new evaluation and thus an update of the confidence level of the certificate. In the case of complaints, it is imaginable that first a dispute is opened in which the certificate holder is also given an opportunity to comment as a respondent on the complaints before these affect a (new) evaluation of the confidence level.

For the evaluation of the third-party information, it can be distinguished according to the quality of the information, confidence status of the informing party, etc., so that a high likelihood of the validity of a set of information (confidence level of the information) is set depending on corresponding different sources of identical information or on information of a source with an especially high confidence level. Obviously, the importance of information for the evaluation of the confidence status of the certificate could also be taken into account, wherein it is conceivable to allocate a corresponding rank to different known types of third-party sources and their information.

In a preferred construction of the invention, the third-party information leads to an evaluation of a rank within a list of ranks by means of a suitable evaluation algorithm, wherein after the certificate is issued, a new evaluation is advantageously also possible with reference to this evaluation algorithm and thus a current rank is calculated.

Such a rank is advantageously provided by the certificate authority online on request for certificate users at any time or at predetermined intervals or actively transmitted to these users. Here it is also conceivable that a current rank is converted to “valid” or “invalid” as a function of a predetermined threshold as known certificate status information, particularly for applications which cannot make use of a rank within a list of ranks with more than two ranks.

Also, if a certificate for a key or usually for a key pair (public and private key) is requested at the certificate authority usually by the holder himself, it is also possible according to the invention that the certificate may be requested by a third party for the holder. In this case it is conceivable that—if desired—an allocation of the (future) certificate holder is obtained from the certificate authority or at the same time transmitted on request. By requesting a certificate for a third party, it is advantageously possible to perform encrypted communications with the third party, without this party already being a holder of a certificate. Just this possibility simplifies computer-assisted communications on digital networks, because even third parties that afterward still do not have a corresponding certificate can participate in encrypted communications without separate activities. In particular, in e-mail traffic or for e-store applications, contact with new partners is simplified in this way.

In another construction of the invention, after a certificate is issued, additional third-party information is continuously collected and used for a new evaluation of the ranking of the confidence status, so that a current confidence status can be requested at any time online by the certificate user.

In a preferred construction of the invention, digital applications on a subscriber station (front end) request information on the current confidence status of a certificate from the certificate authority (CA) before and/or during execution online, so that the application continues to be executed only when validity is confirmed. In this way, the security against misuse is increased in comparison with applications that request or verify a certificate online only once or rarely.

According to the invention, a digital certificate authority in the form of a server (CA server) or a CA system running on a computer has programming means for carrying out the method that is explained above and can exchange information with subscriber stations by means of a digital network, wherein these programming means allow a transmission of third-party information on the certificate holder and an evaluation of rank dependent on this evaluation for a confidence status of the certificate and provide this confidence status online. Such an input possibility for third-party information is not given in known CA systems in the PKI world, so that an evaluation by information and thus an increase in the distribution speed of certificates with a sufficient and advantageously dynamically variable confidence level is made possible for the first time via a CA system with the features according to Claim 9.

If a subscriber station connected to the digital certificate authority by means of a digital network has programming means that request the current confidence status of the certificate needed for the application at the certificate authority before and/or during each execution of an application online and the application continues to execute only when the corresponding rank is confirmed, then the security against misuse for the execution of corresponding applications is increased in an easy and convenient way.

Additional advantageous constructions of the invention are produced from the dependent claims.

The invention will be explained in detail below with reference to the embodiments shown in the drawing.

Shown in the drawing are:

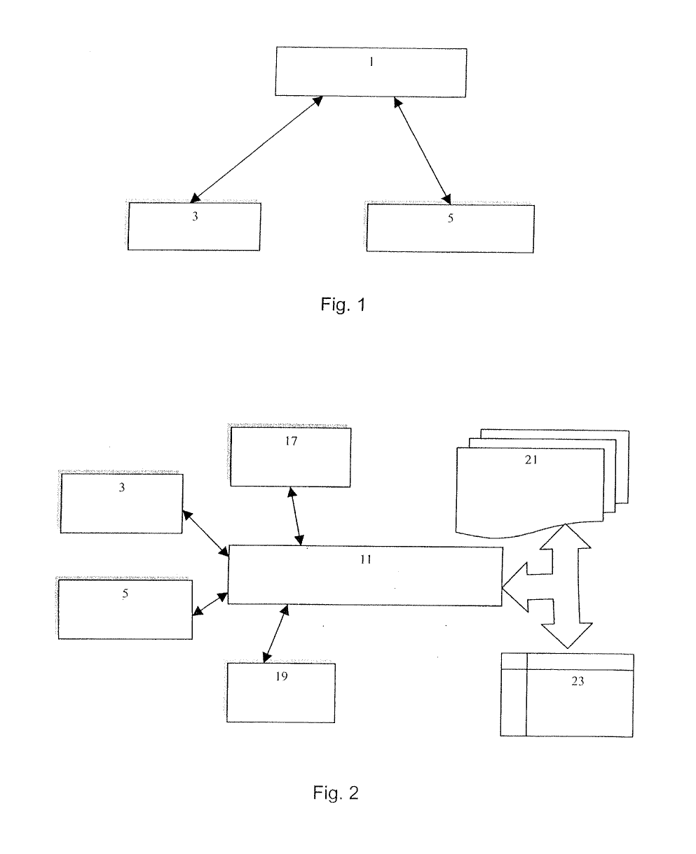

FIG. 1 a schematic block diagram of a known certificate authority and

FIG. 2 a schematic block diagram of a certificate authority according to the invention.

The invention will be explained below with reference to a comparison between a known digital certificate authority 1, as shown in FIG. 1, and a digital certificate authority 11 according to the invention, as shown in FIG. 2, each in the form of a corresponding server or a server application running on a computer and their computer-assisted communications with other subscribers.

With a conventional certificate authority 1 there are, as shown, two types of communications. The (future) certificate holder places a request for a certificate to be issued with the certificate authority 1. Such a request could be realized via the Internet with e-mail feedback or in some other way.

The application or the certificate user 5 that would like to use the certificate communicates with the certificate authority 1, in order to obtain information on the certificate. This communication is performed via an online certificate status protocol (OCSP) or by the receipt of a certificate revocation list (CRL) that is transmitted periodically.

The certificate authority 11 also has, apart from the bidirectional communications paths (shown in FIG. 1 and FIG. 2 by the corresponding double-headed arrows), bidirectional communications paths to the certificate holders 3 and certificate users 5, namely to other so-called digital partner certificate authorities 17 and to digital social networks 19, with which information on the certificate and/or the certificate holder can be transmitted to the certificate authority 11 or even exchanged with each other.

As shown in FIG. 2, according to the invention the collected information on the certificate or on the certificate holder is stored in a database 21 for each certificate, wherein this information is not used for issuing a certificate, but instead is made available for other partner certificate authorities 17, social networks 19, certificate holders 3, and, in particular, certificate users 5 connected online to the digital certificate authority 11 via a digital network. Accordingly, additional information on the certificate is continuously collected and stored by the digital certificate authority 11 after a certificate is issued, wherein, as is clear in FIG. 2, according to a correspondingly suitable evaluation algorithm 23, an appropriate rank of a confidence status within a corresponding rank sequence or list with more than two ranks (that is, more than the attribute “valid” or “invalid”) is allocated to the certificates.

The new evaluation of the rank or the confidence level of a certificate can he performed here as a function of the receipt of new information on the appropriate certificate and/or at specified time intervals. This has the result that, advantageously as a function of the time of receipt of new information, an updated, newly evaluated rank of the confidence level of a certificate is made available online immediately after the evaluation to the subscribers, in particular, the certificate users 5, connected to the digital certificate authority 11.

In contrast to communications with a conventional certificate authority 1, communications take place with this authority not only for issuing a certificate, but also additional information on the certificate after it is issued is sent to the digital certificate authority 11, collected there, evaluated with respect to a confidence rank, and made available online at any time to subscribers 3, 5, 17, 19 connected to the certificate authority 11.

Instead of a revocation list that previously contained a revocation of a certificate and thus a key or a key pair due to the time expiration of the certificate or due to other internal information of the certificate authority 1, such as, for example, an employee leaving a company and thus loss of his authorization and that was not available online at any time for a certificate user 3, but instead at best periodically at large time intervals, according to the method according to the invention, now different ranks are provided online at any time for a confidence status from a list of ranks with more than two levels, so that a certificate user 5, for example, an e-mail sender or an application on a subscriber station can request the current confidence status advantageously before and/or during each execution of an application and the corresponding action is performed only if the current confidence level of the certificate is sufficient.

This method advantageously increases security against misuse. In addition, according to the method according to the invention, as well as the configuration of a digital certificate authority 11 according to the invention, communications are possible and expanded with the subscribers 3, 5, 17, and 19 not only before, but also after a certificate has been issued, so that this information is available more quickly also for other subscribers, which leads to quicker distribution and updating of digital certificates accordingly.

In the following, the advantages produced from the invention will be explained in more detail with reference to two examples of a typical certification process.

### 1ST EXAMPLE

A (future) certificate holder 3, for example, a customer of an e-store application, a sender or receiver of an e-mail with no certificate up until now, etc., requests, after the generation of a key or a key pair at the digital certificate authority 11, a certificate or its signing for this key.

According to the invention, in contrast to previous applications, apart from its own information, it is also possible to use information from third parties, such as, for example, confirmations (endorsements) from third parties of the requested certificate, confirmations of partial details of the certificate, such as, for example, information confirmed by third parties on details of the certificate holder (for example, his address, etc.), confirmations that indicate, through other users, for example, the employee of the certificate holder, his additional background or other persons and organizations with which the certificate holder is associated. Obviously here it is conceivable to allocate a different rank of meaning to this confirming information or confirmations, so that, for example, the confirmation of a bank or a government authority could be weighted greater for a future or current certificate holder than a confirmation of an acquaintance of the certificate holder in a social network.

Such information can be transmitted to the certificate authority 11 by the certificate holder with the request or separate from this request, wherein here the certificate authority 11 could also wait with the issuing of a certificate for at least an announced transmission. The confirming information or confirmations, however, could also be transmitted directly to the certificate authority at the instigation of a third party, typically at the request of the certificate holder.

Obviously it is also possible that the certificate authority 11 obtains, for example, information from appropriate references through the certificate holder at its own instigation from at least parts of the mentioned references or obtains unsolicited information from these references directly.

For the evaluation of the rank of a confidence status, all of the previously mentioned information is evaluated as a function of its meaning by means of a suitable evaluation algorithm 23 for a rank, wherein, in contrast to the conventional issuing of a certificate, not only internally present parameters are used conventionally in certificate authorities 1 for identity verification, but instead, as explained above, also third-party information is significantly incorporated here. In addition, it is conceivable that earlier information on the certificate holder, such as, for example, the history of earlier certificates that were issued for the same certificate holder, etc., is likewise used for evaluating the confidence level.

A decision of the certificate authority on the confidence status of a certificate can here be made, for example, also as a function of the weighting of the information and/or the status of the third party itself. For example, the weighting of a confirmation by a third party could depend on the digital identity of the third party (its certificate class or level, whether and which certificate authority issued the certificate of the third party, etc.) and/or the history of the third party (how many certificates confirmed by this third party were later revoked due to misuse).

A correlation between confirmations could also be made on the basis of partial information on the identities of the (confirming) third parties.

For example, the certificate authority could assume that it involves the same person if several (confirming) third parties have the same first and last names, while other characteristics are different. Consequently, these multiple confirmations (of a single third party) could be weighted less than confirmations of different third parties.

It is also conceivable that first name, last name, and other information in the certificate of the confirming third party is analyzed with respect to its consistency, in particular, when it involves a Class 1 certificate or a high-value certificate issued by a less well-known or less reliable certificate authority. For example, an unreadable name in the identity of the confirming third party states nothing about the actual person (behind the name). Likewise, a confirmation of a third party with the name of a famous personality (for example, from the west) that is obviously being used improperly (identifiable from an inconsistency with respect to additional information, such as, for example, the location information “coming from the far east”) would be given absolutely no or, in any case, very minimal weighting.

Furthermore, it is conceivable to form a correlation between various or different confirmations of partial information. Thus, different third parties could confirm the same person in that each third party confirms only that (partial) information that is known and trusted. Through the formation of such a correlation, the confidence level can be increased by means of a corresponding algorithm by a linear measure (simple addition of the confirmations).

As an additional possibility of correlation between multiple sets of information, it is conceivable to take into account the relationship between the identity of a subscriber and that of the confirming third party. For example, a confirmation by a third party who belongs to the same company as the certificate holder would be weighted greater than the confirmation by a third party who belongs to a social network. With respect to mailing address, a confirmation by a third party from the same family (especially living in the same country) could be weighted greater than a confirmation by someone else.

As already explained, the issued certificates are stored together with the current confidence level in the certificate authority 11 in the database memory 21, so that certificate users 5 could obtain these online at any time, for example, via OCSP or the like. The certificate authority 11 here transmits the rank or the confidence level of the certificate to the certificate user 5.

In addition to the report on the confidence level of the certificate, the digital certificate authority 11 could also send back, at least on request, the certificate of a certain certificate holder to a certificate user 5 or someone else after identification of a corresponding identification feature, for example, the e-mail address of the certificate holder. Here, it is conceivable that the digital certificate authority 11 accepts as such identification features, also sub-features, such as, for example, first and last names of a desired certificate holder 5, in order to send back a list of certificates that possibly belong to the desired certificate holder 5 or correspond to the request. In order to prevent misuse, especially for spam purposes, the digital certificate authority 11 could provide suitable countermeasures. For example, the number of certificates for such a request could be limited to a predefined number.

As already explained above, the digital certificate authority 11 could also collect additional information on a certificate, such as confirmations and complaints, after the certificate has been issued, in order to determine a new, updated confidence level of the corresponding certificate.

If the confidence level of a certificate falls below a predetermined value or rank, the digital certificate authority 11 could declare the certificate revoked or invalid and report this by means of OCSP or the revocation list to other, in particular, certificate users 5. In this way, in particular, applications that understand only the attributes of “certificate valid” or “certificate invalid” are still supported for compatibility reasons.

Advantageously, however, information on a certificate, especially its revocation, is actively reported by the certificate authority 11 to corresponding subscribers. For example, a report to certificate users 5 on a revocation of certificates that were already requested earlier is performed by means of an automatic update function preset in the application in the form of revocation lists or some other form.

The certificate users 5 could receive the status of the certificate also by means of OCSP as the attribute “revoked” or “invalid,” if the rank or the confidence level falls below a predefined value or rank.

Obviously it is also conceivable that the certificate authority 11 also stores certificates that were issued by other certificate authorities, wherein an evaluation for these certificates can differ from the evaluation of certificates issued by itself, for example, by the application of a different parameter of the evaluation algorithm 23 or by the application of a different corresponding evaluation algorithm.

### 2ND EXAMPLE

According to the invention, it is also possible that, instead of the certificate holder, also a third party, for example, the certificate user 5 requests, at the certificate authority 11, a certificate for a different subscriber, that is, the future certificate holder 3. In this case, the digital certificate authority 11 performs some tests with the aid of its own knowledge or information and the knowledge or information of third parties. For example, the request could be rejected if a certificate that could be used (internal knowledge) already exists for the future certificate holder.

Furthermore, it could be required that the certificate type must match the requester profile; for example, an e-mail user may request an e-mail certificate for the other e-mail subscribers (for example, receivers), in contrast, not for an SSL certificate. In the permissible case, the certificate authority 11 generates the key and registers the certificate and the requester receives his requested certificate back.

In addition, the certificate authority 11 transmits the generated key and the certificate to the certificate holder on a protected path. For example, this could be sent to the e-mail address belonging to the certificate as a PFX file (personal information exchange), while the password is transmitted with another mail or on another digital channel. Here it can be necessary that the newly generated certificate is not available for third parties until it has been confirmed by the receiver, in order to prevent misuse. If the receiver does not confirm the certificate within a certain period, the certificate authority 11 can also, however, automatically revoke the certificate. Alternatively, the receiver could use the certificate one time, for example, for reading the encrypted e-mail sent to him by the requester and later request his own separate certificate, so that the certificate expires after one-time use.

This method simplifies access to PKI-based security for different Web-based applications or users in general, because, for example, an Internet-shop owner, no longer has to impose the generation of a key and the request of a certificate on his customer or a sender to a recipient of the customer or on the recipient as a precondition for participation in the secure communications, but instead these steps can be carried out in a customer-friendly or user-friendly way. This significantly increases the convenience for the customers and recipients—in addition to increased security with respect to the confidence level of the certificate, as previously explained, so that there are no conditions felt to be cumbersome or lack of knowledge of the users standing in the way of further and quicker distribution of certificates.

According to the invention it is essential that, instead of a decentralized, mutual signing of keys, a certificate is requested and issued at a central, digital certificate authority, wherein, for increasing the quality of the certificate, the certificate authority makes additional third-party information accessible. This information can be taken into account not only when a certificate is issued, but also can be used for evaluating the quality of the certificate or the confidence status of a certificate. Here, advantageously the confidence status could be provided to each certificate user in an updated manner, increasing the security for use (communication, application, etc.).

1. Method for issuing, verifying, and distributing digital certificates for use in Public Key Infrastructure, in which a requester (3, 5) requests a digital certificate at a digital certificate authority (11),
characterized in that
a) for evaluating a confidence status for the certificate of a certificate holder (3), at least one set of third-party information (21) on the certificate holder (3) is referenced.

2. Method according to claim 1, characterized in that the at least one set of third-party information (21) is obtained by the certificate authority (11) from third parties (5, 17, 19) by means of a digital connection, in particular, via an Internet connection, or transmitted directly to the certificate authority (11) from third parties (5, 17, 19) or from the requestor (3, 5).

3. Method according to claim 1 or 2, characterized in that the at least one set of third-party information (21) leads to the evaluation of a rank within a list of ranks by means of a suitable evaluation algorithm (23).

4. Method according to claim 3, characterized in that one set of information on the rank of the calculated confidence status is provided by the certificate authority (11) on request online for certificate users (5).

5. Method according to one of the preceding claims, characterized in that the certificate is requested by the holder (3).

6. Method according to one of claims 1-4, characterized in that the certificate is requested for the holder by a third party (5, 17, 19).

7. Method according to one of the preceding claims, characterized in that, after a certificate is issued, additional third-party information (2) is continuously collected and used for a new evaluation of the rank of the confidence status, so that a current confidence status can be requested at any time online by the certificate user (5).

8. Method according to claim 7, characterized in that a digital application on a subscriber station (front end) of a certificate user (5) requests information on the current confidence status of a certificate from the digital certificate authority (CA) online before and/or during the execution and the application continues to be executed only if the validity of the certificate is confirmed.

9. Digital certificate authority for carrying out a method according to one of the preceding claims, which can exchange information by means of a digital network with subscriber stations,
characterized in that
the digital certificate authority (11) has programming means that allow a transmission of third-party information (21) on the certificate holder (3) and an evaluation of this information with respect to a rank dependent on this evaluation of a confidence status of the certificate and provide this confidence status online.

10. Arrangement made from a digital certificate authority according to claim 9 and at least one subscriber station of a certificate user (5) connected to this certificate authority by means of a digital network, wherein this arrangement has programming means that request the current confidence status of the certificate needed for the application at the certificate authority (11) online before and/or during each execution of an application and continue to execute the application only if the appropriate rank is confirmed.
